(19) United States
(12) Patent Application Publication
(10) Pub. No.: US 2026/0249560 A1
(43) Pub. Date: Aug. 27, 2026

(54) SYSTEMS AND METHODS FOR PROCESSING A WORKPIECE

(71) Applicant: University of Washington, Seattle, WA (US)

(72) Inventors: Aniruddh VASHISTH, Seattle, WA (US); Ashis G. BANERJEE, Seattle, WA (US); Yuan-Chuan LIN, Seattle, WA (US); Sai Krishna MURAKONDA, Seattle, WA (US); Rauf KAREEM, Seattle, WA (US)

(21) Appl. No.: 18/877,483

(22) PCT Filed: Jun. 20, 2023
(86) PCT No.: PCT/US2023/025714

§ 371 Date: Dec. 20, 2024

Related U.S. Application Data
(60) Provisional application No. 63/366,680, filed on Jun. 20, 2022.

(51) Int. Cl. B29C 65/04; B29C 65/00; B29C 65/34

(52) U.S. Cl. CPC B29C 65/04; B29C 65/3412; B29C 66/91211; B29C 66/91421

(57) ABSTRACT

A method includes irradiating, via a heating element, a first portion of a workpiece with electromagnetic radiation having an oscillation frequency within a range of 1 MHz to 300 MHz, thereby heating the first portion of the workpiece. The method also includes applying a pressure to the first portion of the workpiece via an actuator and making a determination that a condition of the first portion or the actuator satisfies one or more criteria. The method also includes moving the workpiece and/or the actuator, in response to making the determination, such that a second portion of the workpiece is aligned with the actuator. A system includes one or more processors, an infrared camera, an actuator, a platform, a motor, a power source, a load cell, and a computer readable medium storing instructions that, when executed by the one or more processors, cause the system to perform the method.

### CROSS-REFERENCE TO RELATED APPLICATION

This application claims priority to U.S. Provisional Patent Application No. 63/366,680, filed on Jun. 20, 2022, the entire contents of which is incorporated by reference herein.

### BACKGROUND

Various methods are used for welding polymers or composite materials together, such as induction welding, resistance welding, and ultrasonic welding. While these methods have industrial applications, recent focus on rapid manufacturing in the automotive and aerospace industry has highlighted the need for faster, safer, and more reliable heating and welding methods.

### SUMMARY

A first example is a method comprising: irradiating, via a heating element, a first portion of a workpiece with electromagnetic radiation having an oscillation frequency within a range of 1 MHz to 300 MHz, thereby heating the first portion of the workpiece; applying a pressure to the first portion of the workpiece via an actuator; making a determination that a condition of the first portion or the actuator satisfies one or more criteria; and moving the workpiece and/or the actuator, in response to making the determination, such that a second portion of the workpiece is aligned with the actuator.

A second example is a non-transitory computer readable medium storing instructions that, when executed by one or more processors of a bonding system, cause the bonding system to perform the method of the first example.

A third example is a bonding system comprising: one or more processors; an infrared camera; a heating element; an actuator; a platform; a motor; a power source; a load cell; and a computer readable medium storing instructions that, when executed by the one or more processors, cause the bonding system to perform the method of the first example.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of a bonding system, according to an example.

FIG. 2 is a schematic diagram of a bonding system and a workpiece, according to an example.

FIG. 3 is a schematic diagram of a bonding system and a workpiece, according to an example.

FIG. 4 is a schematic diagram of a robotic arm and a platform, according to an example.

FIG. 5 is a schematic diagram of a robotic arm, according to an example.

FIG. 6 is a block diagram of a method, according to an example.

### DETAILED DESCRIPTION

This disclosure includes examples of a bonding system and methods for its operation. The bonding system includes one or more processors, an infrared camera, a heating element, an actuator, a platform, a motor, a power source, a load cell, and a computer readable medium storing instructions that, when executed by the one or more processors, cause the bonding system to perform a method.

The method includes irradiating, via the heating element, a first portion of a workpiece with electromagnetic radiation having an oscillation frequency within a range of 1 MHz to 300 MHz, thereby heating the first portion of the workpiece. Typically, the heating element is a planar radio frequency antenna operably coupled to a power source. The workpiece generally includes multiple layers of composite material infused with particles that are efficient absorbers of the electromagnetic radiation. The method also includes applying a pressure to the first portion of the workpiece via an actuator (e.g., a compaction roller coupled to a motorized piston) and making a determination that a condition of the first portion or the actuator satisfies one or more criteria. The one or more criteria can include whether the first portion of the workpiece has reached a threshold temperature as detected by the infrared camera, whether the actuator has applied a threshold pressure to the first portion of the workpiece as detected by the load cell, and/or whether the actuator has displaced the first portion of the workpiece by a threshold displacement. The method also includes moving the workpiece and/or the actuator, in response to making the determination, such that a second portion of the workpiece is aligned with the actuator. In this way, portions of the workpiece are sequentially processed and verified to satisfy one or more processing criteria.

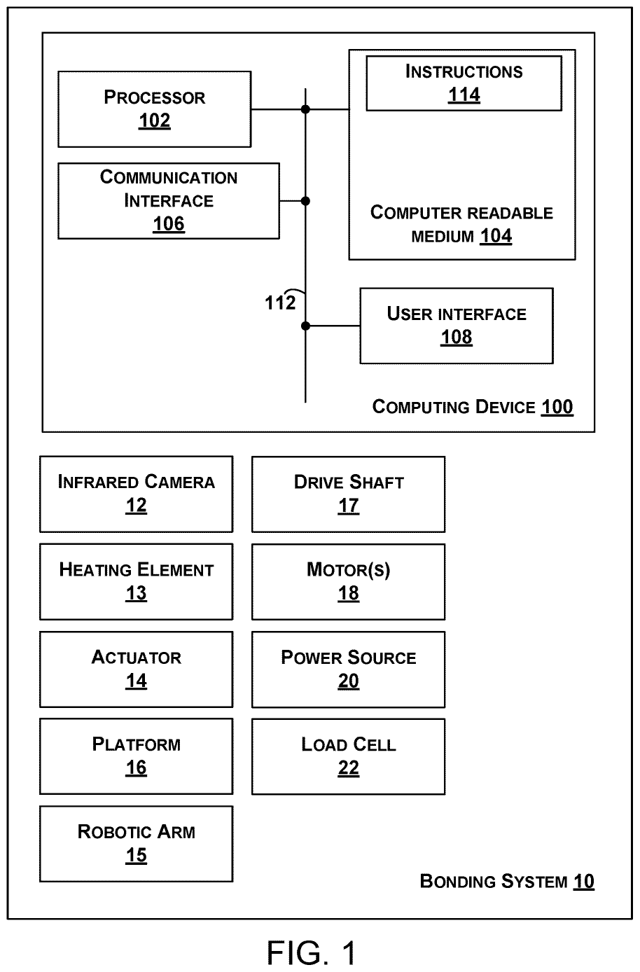

FIG. 1 is a block diagram of a bonding system 10. The bonding system 10 includes a computing device 100, an infrared camera 12, a heating element 13, an actuator 14, a robotic arm 15, a platform 16, a drive shaft 17, motor(s) 18, a power source 20, and a load cell 22.

The computing device 100 includes one or more processors 102, a non-transitory computer readable medium 104, a communication interface 106, and a user interface 108. Components of the computing device 100 are linked together by a system bus, network, or other connection mechanism 112.

The one or more processors 102 can be any type of processor(s), such as a microprocessor, a field programmable gate array, a digital signal processor, a multicore processor, etc., coupled to the non-transitory computer readable medium 104.

The non-transitory computer readable medium 104 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 104 can store instructions 114. The instructions 114 are executable by the one or more processors 102 to cause the computing device 100 to perform any of the functions or methods described herein.

The communication interface 106 can include hardware to enable communication within the computing device 100 and/or between the computing device 100 and one or more other devices. The hardware can include any type of input and/or output interfaces, a universal serial bus (USB), PCI Express, transmitters, receivers, and antennas, for example. The communication interface 106 can be configured to facilitate communication with one or more other devices, in accordance with one or more wired or wireless communication protocols. For example, the communication interface 106 can be configured to facilitate wireless data communication for the computing device 100 according to one or more wireless communication standards, such as one or more Institute of Electrical and Electronics Engineers (IEEE) 801.11 standards, ZigBee standards, Bluetooth standards, etc. As another example, the communication interface 106 can be configured to facilitate wired data communication with one or more other devices. The communication interface 106 can also include analog-to-digital converters (ADCs) or digital-to-analog converters (DACs) that the computing device 100 can use to control various components of the computing device 100 or external devices.

The user interface 108 can include any type of display component configured to display data. As one example, the user interface 108 can include a touchscreen display. As another example, the user interface 108 can include a flat-panel display, such as a liquid-crystal display (LCD) or a light-emitting diode (LED) display. The user interface 108 can include one or more pieces of hardware used to provide data and control signals to the computing device 100. For instance, the user interface 108 can include a mouse or a pointing device, a keyboard or a keypad, a microphone, a touchpad, or a touchscreen, among other possible types of user input devices. Generally, the user interface 108 can enable an operator to interact with a graphical user interface (GUI) provided by the computing device 100 (e.g., displayed by the user interface 108).

The infrared camera 12 includes optical elements such as lenses and an image sensor configured to generate an array of pixel values that represent temperatures of an object captured by the infrared camera 12. Generally, the infrared camera 12 provides images to the computing device 100.

The heating element 13 typically takes the form of a planar radio frequency antenna that is operably coupled to the power source 20.

The actuator 14 takes the form of a compaction roller attached to a piston that is controlled and powered by a motor 18.

The robotic arm 15 can be articulable and can include the actuator 14 and/or heating element 13 disposed thereon.

The platform 16 can include any sturdy surface suitable for supporting a workpiece during processing by the bonding system 10. The platform 16 can be formed of a polymer, an acrylic, and/or glass. In various examples, the platform 16 can be substantially flat or curved.

The motor(s) 18 takes the form of a servo motor or a stepper motor configured to spin the threaded drive shaft 17, thereby moving the platform 16 and also a servo motor or a stepper motor configured to move the robotic arm 15, the heating element 13, and/or the actuator 14 (e.g., in unison). The motors(s) 18 are controlled by the computing device 100.

The power source 20 can include a signal generator and/or a radio frequency amplifier configured to provide an electrical current waveform with controllable amplitude and frequency components to the heating element 13. The power source 20 is controlled by the computing device 100.

The load cell 22 is configured to provide an electrical signal to the computing device 100 that indicates an amount of pressure or force applied to the workpiece by the actuator 14.

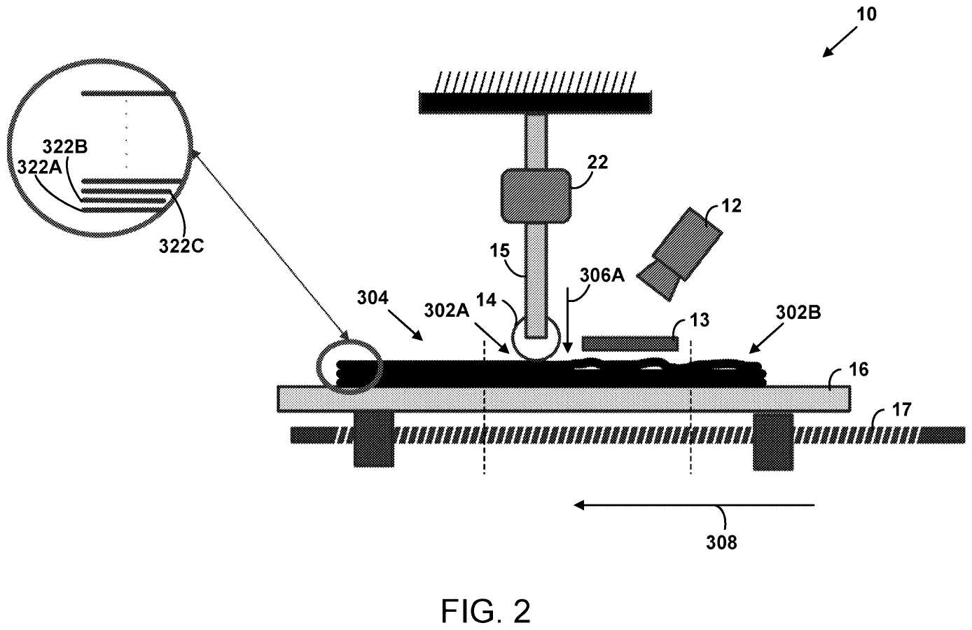

FIG. 2 is a schematic diagram of the bonding system 10 and a workpiece 304.

The workpiece 304 includes particles embedded within a matrix material. The particles are metallic, carbon-based, ceramic, carbon nanotubes, graphene, graphite, graphene oxide, laser-induced graphene, carbon black, carbon fibers, char, silicon carbide, and/or MXene. The matrix material includes thermoplastic, thermoset, glass, polytetrafluoroethylene, polyetheretherketone, covalent adaptive network polymers, polymer-derived ceramics, and/or other polymers or ceramics. The workpiece 304 is generally formed layer by layer by the bonding system 10, as described in more detail below.

The computing device 100 causes the heating element 13 of the bonding system 10 to irradiate a portion 302A of the workpiece 304 with electromagnetic radiation having one or more oscillation frequencies within a range of 1 MHz to 300 MHz (e.g., 1 MHz to 200 MHz), thereby heating the portion 302A of the workpiece 304. That is, the computing device 100 causes the power source 20 to provide electric current having one or more oscillation frequencies within a range of 1 MHz to 300 MHz to the heating element 13. As shown by the vertical dotted lines, the portion 302A is substantially centered underneath the actuator 14 and the heating element 13. Generally, the portion 302A, including the matrix material and the particles embedded within the matrix material, is heated via the particles absorbing the electromagnetic radiation. That heat spreads through the matrix material via thermal conduction. The heating element 13 typically irradiates the portion 302A while the heating element 13 is displaced from the portion 302A by a distance within a range of 1 mm to 2 mm.

The computing device 100 also causes the actuator 14 (e.g., via the robotic arm 15) to apply a pressure 306A to the portion 302A of the workpiece 304. The actuator 14 generally applies the pressure 306A simultaneously with the heating element 13 irradiating the portion 302A. As shown, the actuator 14 takes the form of a compaction roller coupled to a piston powered by a motor 18 (not shown) that applies the pressure 306A to the portion 302A. FIG. 2 shows a cross-section of the compaction roller within a plane that is normal to the elongated dimension of the compaction roller. The workpiece 304, and thus the portion 302A and the portion 302B, generally have a width along the elongated dimension of the compaction roller that is comparable to that of the compaction roller.

Additionally, the computing device 100 makes a determination that a condition of the portion 302A or the actuator 14 satisfies one or more criteria. In various examples, the one or more criteria include whether the portion 302A has reached a threshold temperature as detected by the infrared camera 12, whether the actuator 14 has applied a threshold pressure to the portion 302A as detected by the load cell 22, and/or whether the actuator 14 has displaced the portion 302A by a threshold displacement.

In many embodiments, the one or more criteria for beginning to process another portion of the workpiece 304 include whether the threshold temperature has been achieved for the portion 302A. As such, the computing device 100 uses one or more images captured by the infrared camera 12 to determine that a temperature of the portion 302A exceeds a threshold temperature, such as a threshold temperature within a range of 30° C. to 800° C., or more particularly within a range of 30° C. to 500° C. for a polymer matrix material, or within a range of 100° C. to 800° C. for a ceramic matrix material. Thus, the computing device 100 detects the temperature of the portion 302A using the infrared camera 12 and adjusts a current provided to the heating element 13 by the power source 20, thereby reducing the difference between the threshold temperature and the temperature of the portion 302A. The temperature of the portion 302A detected or determined by the infrared camera 12 could be a minimum temperature of the entire portion 302A, a maximum temperature of the entire portion 302A, or an average temperature of the entire portion 302A.

In some embodiments, the one or more criteria for beginning to process another portion of the workpiece 304 also includes whether the pressure 306A applied to the portion 302A by the actuator 14 exceeds a threshold pressure, such as a threshold pressure within a range of 1 MPa to 10 MPa. Thus, the computing device 100 uses the load cell 22 to detect the pressure 306A and adjusts the pressure 306A applied to the portion 302A to reduce a difference between the threshold pressure and the pressure 306A applied to the portion 302A. The computing device 100 can use proportional-integral-differential control to reduce the difference between the threshold pressure and the pressure 306A applied to the portion 302A.

In some embodiments, the one or more criteria for beginning to process another portion of the workpiece 304 also include whether a displacement of the actuator 14 with respect to a reference position exceeds a threshold displacement. That is, the computing device 100 uses encoder output from a motor 18 controlling the robotic arm 15 to determine a vertical position of the actuator 14. If the vertical position of the actuator 14 is at least a threshold displacement lower than the position of the actuator 14 detected when the actuator 14 made initial contact with the portion 302A, then this criterion is satisfied. In various examples, the threshold displacement is within a range of 0.1 mm to 10 cm.

Once the computing device 100 determines that the one or more criteria have been satisfied, the computing device 100 causes the workpiece 304 and/or the actuator 14 to move horizontally such that a portion 302B of the workpiece 304 is aligned with the actuator 14 and the heating element 13. For example, a motor 18 can turn the drive shaft 17, thereby moving the platform 16 and the workpiece 304 to the left (e.g., in a direction that is perpendicular to the direction of elongation of the actuator 14).

In some examples, the computing device 100 determines a temperature difference between the temperature of the portion 302A and the threshold temperature and determines a translation speed 308 based on the temperature difference. For example, the translation speed 308 could be inversely proportional to the temperature difference. The computing device 100 then moves the workpiece 304 and the actuator 14 relative to each other according to the translation speed 308, generally by using a motor 18 to turn the drive shaft 17 which results in movement of the platform 16. In some examples, the computing device 100 uses proportional-integral control to move the workpiece 304 and/or the actuator 14 according to the translation speed.

Once the computing device 100 determines that the portion 302A has been processed according to the one or more criteria discussed above and the portion 302B has been moved under the heating element 13 and the actuator 14, the portion 304B will be processed.

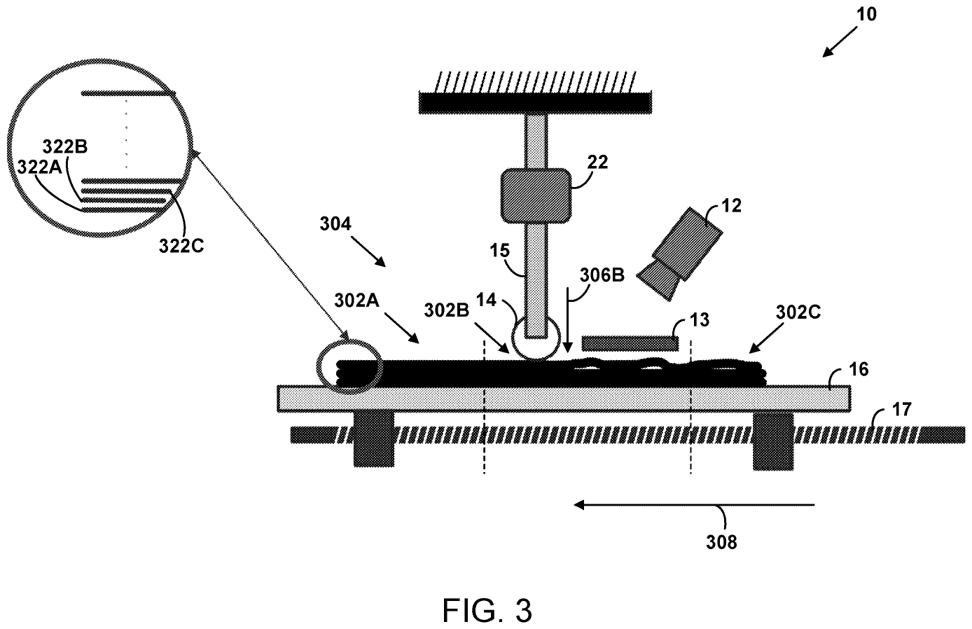

As shown in FIG. 3 (not to scale), the computing device 100 causes the heating element 13 to irradiate the portion 302B with the electromagnetic radiation, thereby heating the portion 302B. The computing device 100 also causes the actuator 14 to apply a pressure 306B to the portion 302B. As described above with respect to the processing of the portion 302A, the computing device 100 also determines that a condition of the portion 302B or the actuator 14 while pressing the portion 302B satisfies the aforementioned one or more criteria. In response to the computing device 100 determining that the one or more criteria have been satisfied with respect to the portion 302B, the computing device 100 moves the workpiece 304 and/or the actuator 14 such that a portion 302C of the workpiece 304 is aligned with the actuator 14 and/or the heating element 13.

In various examples depicted by FIG. 2, the workpiece 304 is formed of many layers such as a layer 322A, a layer 322B on the layer 322A, a layer 322C on the layer 322B, and so on. Accordingly, the bonding system 10 bonds the layer 322A to the layer 322B via the heating element 13 irradiating the portion 302A of the layer 322A and the layer 322B with the electromagnetic radiation and the actuator 14 applying the pressure 306A to the portion 302A of the layer 322A and the layer 322B. As shown in FIG. 3, the bonding system 10 further bonds the layer 322A to the layer 322B via the heating element 13 irradiating the portion 302B of the layer 322A and the layer 322B with the electromagnetic radiation and the actuator 14 applying the pressure 306B to the portion 302B of the layer 322A and the layer 322B.

Thereafter, as shown in FIG. 2, the layer 322C is placed upon the layer 322B and the heating element 13 irradiates the portion 302A again and the actuator 14 applies the pressure 306A to the portion 302A again to bond the layer 322C and the layer 322B. In response to the portion 302A and/or the actuator 14 satisfying the aforementioned one or more criteria, the bonding system 10 moves the workpiece 304 and/or the actuator 14 such that the portion 302B of the layer 322B and the layer 322C is aligned with the actuator 14 and the heating element 13 as shown in FIG. 3.

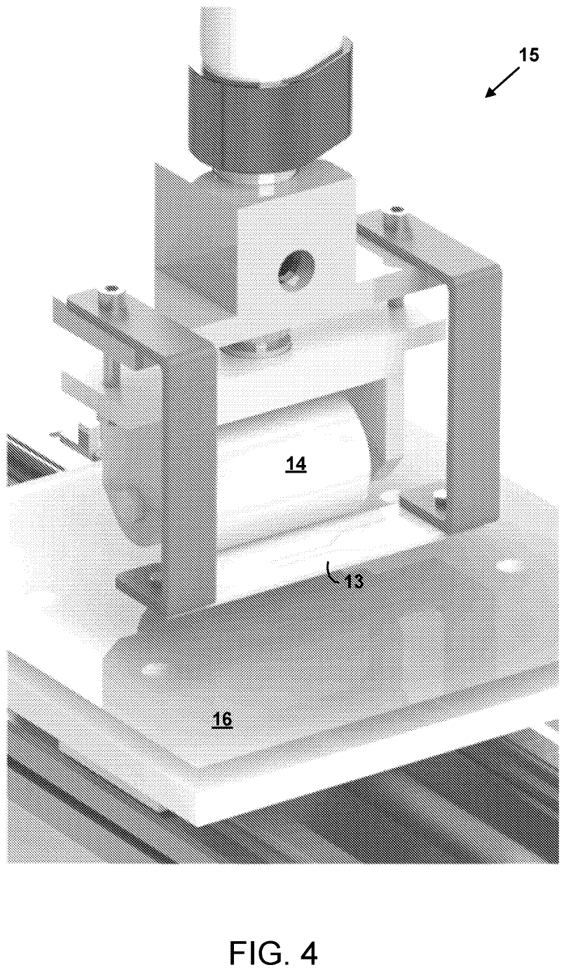

FIG. 4 is a schematic diagram of the robotic arm 15 and the platform 16.

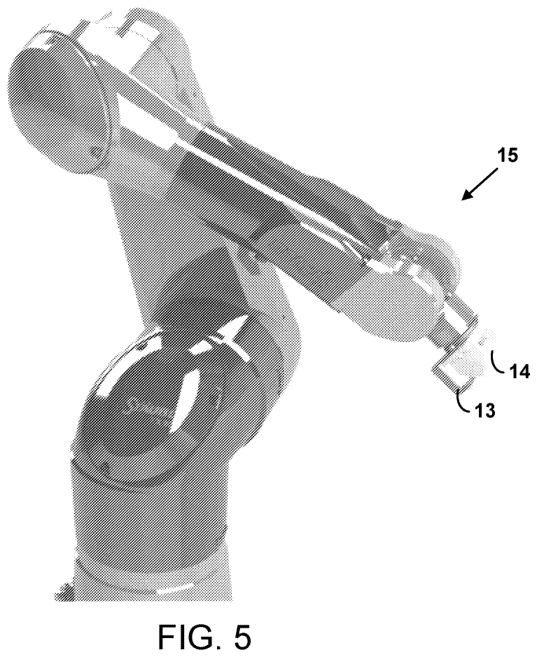

FIG. 5 is a schematic diagram of the robotic arm 15.

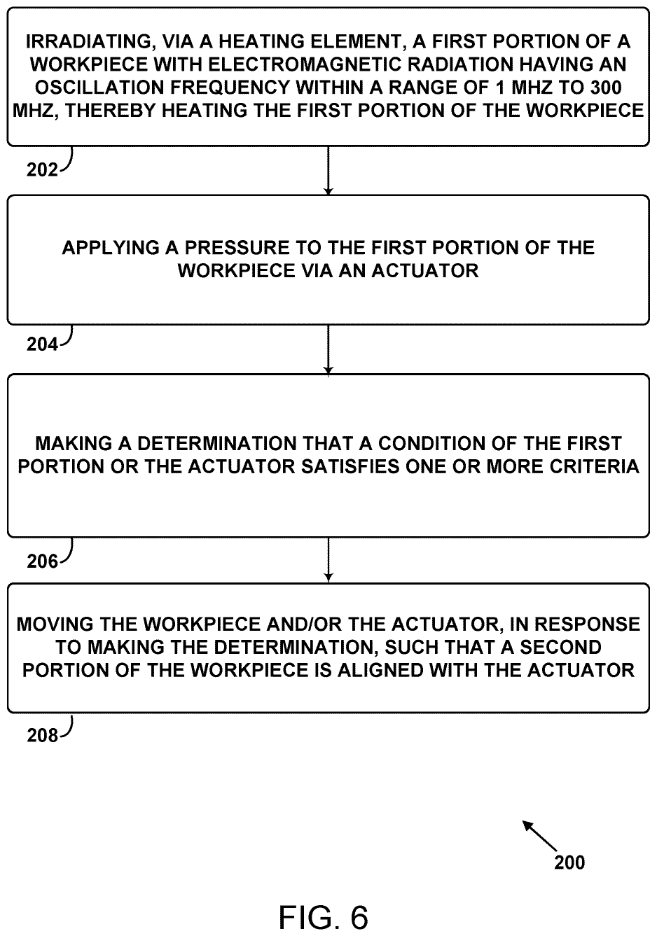

FIG. 6 is a block diagram of a method 200, which in some examples is performed by the bonding system 10. As shown in FIG. 6, the method 200 includes one or more operations, functions, or actions as illustrated by blocks 202, 204, 206, and 208. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes the bonding system 10 irradiating, via the heating element 13, the portion 302A of the workpiece 304 with electromagnetic radiation having an oscillation frequency within a range of 1 MHz to 300 MHz, thereby heating the portion 302A of the workpiece 304. Functionality related to block 202 is described above with reference to FIGS. 2-3.

At block 204, the method 200 includes the bonding system 10 applying the pressure 306A to the portion 302A of the workpiece 304 via the actuator 14. Functionality related to block 204 is described above with reference to FIGS. 2-3.

At block 206, the method 200 includes the bonding system 10 making the determination that the condition of the portion 302A or the actuator 14 satisfies the one or more criteria. Functionality related to block 206 is described above with reference to FIGS. 2-3.

At block 208, the method 200 includes the bonding system 10 moving the workpiece 304 and/or the actuator 14, in response to making the determination, such that the portion 302B of the workpiece 304 is aligned with the actuator 14. Functionality related to block 208 is described above with reference to FIG. 2-3.

### FURTHER EXAMPLES

The heating element can take the form of a planar RF antenna that is operably connected to a signal generator and/or an amplifier. The heating element is generally positioned adjacent to the actuator such that the electromagnetic radiation can be suitably introduced to the portion of the workpiece that is under pressure applied by the actuator (e.g., a compaction roller attached to the actuator). The heating element generally does not make contact with the workpiece, instead a gap of approximately 1-2 mm exists and the electromagnetic radiation induces currents within conductive filler material that is part of the workpiece, which heats the workpiece internally. The heating is generally localized within a thin region of the workpiece that faces and is closest to the heating element. The controlled application of heat and pressure causes layers of the workpiece to bond together. As the desired temperature and pressure is reached for an elongated portion of the workpiece that is aligned with the elongated roller actuator, a platform can move the workpiece such that the next elongated portion of the workpiece is moved into alignment with the actuator and the heating element. As such, portions of the workpiece are sequentially bonded as each portion reaches the desired pressure and temperature. As referred to herein, “portions” of the workpiece can be completely distinct or can have some degree of overlap in area and/or volume with each other.

The workpiece generally takes the form of a composite material having conductive filler materials therein. For example, the composite material can include Carbon Fiber PEEK (CF/PEEK), ceramics, polymers, thermoplastic, and/or thermoset, and can include carbon-based (e.g., electrically conductive) fillers such as carbon nanotubes, graphene, graphite, graphene oxide, laser induced graphene, carbon black, carbon fibers, char, or MXene.

The heated workpiece will radiate infrared radiation (e.g., 780 nm to 1 mm) like any heated object. The wavelengths of the infrared radiation serves as a proxy for a temperature of the workpiece. Thus, an infrared camera can be used to infer the temperature of the portion of the workpiece that is aligned with the heating element and the actuator. The inferred temperature is used in a closed feedback loop to adjust the RF power of the heating element as needed to achieve the desired temperature within the workpiece. The desired processing temperature for the workpiece can be anywhere from slightly above room temperature (e.g., 25° C.) to 800° C.

The actuator can take the form of a compaction roller attached to a motorized piston, and is generally configured to apply a controllable pressure and/or to displace or press the (e.g., melted or softened) workpiece in a controllable manner over a target displacement distance. A load cell is used to monitor the pressure and/or displacement applied to the workpiece. The detected pressure is used in a closed feedback loop to adjust the force applied by the actuator as needed to achieve the desired pressure on the workpiece. The desired processing pressure for the actuator/workpiece can be 1 MPa to 10 MPa, for example.

Additionally, a maximum temperature can be set (e.g., via user input). That is, the temperature of the workpiece can be kept below the maximum temperature, for example, a temperature at which the materials of the workpiece are known to (e.g., irreversibly) break down or deteriorate.

A conveyor type platform can be used to move the workpiece relative to the heating element and/or the actuator such that the time that that a given portion of the workpiece is subject to the electromagnetic radiation and/or the pressure applied by the actuator is dependent on the translation speed of the platform. That is, if the detected temperature and the detected pressure are being effectively controlled as desired, then the platform translation speed can perhaps be increased. If there is an undesirable mismatch between target temperature/pressure and what is detected, the translation speed of the platform may be slowed down to allow time for control systems to compensate.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. A method comprising:
irradiating, via a heating element, a first portion of a workpiece with electromagnetic radiation having an oscillation frequency within a range of 1 MHz to 300 MHz, thereby heating the first portion of the workpiece;
applying a pressure to the first portion of the workpiece via an actuator;
making a determination that a condition of the first portion or the actuator satisfies one or more criteria; and
moving the workpiece and/or the actuator, in response to making the determination, such that a second portion of the workpiece is aligned with the actuator.

2. The method of claim 1, wherein applying the pressure comprises applying the pressure simultaneously with irradiating the first portion.

3. (canceled)

4. The method of claim 1, wherein making the determination comprises determining that a temperature of the first portion exceeds a threshold temperature.

5. (canceled)

6. The method of claim 4, further comprising:
detecting the temperature using an infrared camera; and
adjusting a current provided to the heating element, thereby reducing a difference between the threshold temperature and the temperature of the first portion.

7. The method of claim 4, wherein the temperature is a minimum temperature of the first portion, a maximum temperature of the first portion, or an average temperature of the first portion.

8. The method of claim 4, wherein making the determination further comprises determining a temperature difference between the temperature of the first portion and the threshold temperature, the method further comprising:
determining a translation speed based on the temperature difference,
wherein moving the workpiece and/or the actuator comprises moving the workpiece and/or the actuator according to the translation speed.

9. (canceled)

10. The method of claim 4, wherein making the determination further comprises determining that the pressure exceeds a threshold pressure.

11. (canceled)

12. The method of claim 10, further comprising:
detecting the pressure using a load cell; and
adjusting the pressure applied to the workpiece to reduce a difference between the threshold pressure and the pressure applied to the workpiece.

13. (canceled)

14. The method of claim 4, wherein making the determination further comprises determining that a displacement of the actuator with respect to a reference position exceeds a threshold displacement.

15. (canceled)

16. (canceled)

17. The method of claim 1, wherein the heating element comprises a planar radio frequency antenna.

18. (canceled)

19. The method of claim 1, wherein
the first portion is elongated along a first direction, and
moving the workpiece and/or the actuator comprises moving the workpiece and/or the actuator in a second direction that is perpendicular to the first direction.

20. The method of claim 19, wherein the actuator comprises a compaction roller that is elongated along the first direction.

21. The method of claim 1, wherein the workpiece comprises particles embedded within a matrix material, wherein heating the first portion of the workpiece comprises heating the particles via the particles absorbing the electromagnetic radiation.

22. The method of claim 21, wherein the particles are metallic, carbon-based, ceramic, carbon nanotubes, graphene, graphite, graphene oxide, laser-induced graphene, carbon black, carbon fibers, char, silicon carbide, or MXene.

23. The method of claim 21, wherein the matrix material comprises thermoplastic, thermoset, glass, polytetrafluoroethylene, polyetheretherketone, or other polymers.

24. The method of claim 23, wherein making the determination comprises determining that a temperature of the first portion exceeds a threshold temperature, wherein the matrix material comprises a polymer, and wherein the threshold temperature is within a range of 30° C. to 500° C.

25. (canceled)

26. (canceled)

27. (canceled)

28. (canceled)

29. (canceled)

30. (canceled)

31. The method of claim 1, further comprising:
irradiating, via the heating element, the second portion of the workpiece with the electromagnetic radiation, thereby heating the second portion of the workpiece;
applying a second pressure to the second portion of the workpiece via the actuator;
making a second determination that a second condition of the second portion or the actuator satisfies the one or more criteria; and
moving the workpiece and/or the actuator, in response to making the second determination, such that a third portion of the workpiece is aligned with the actuator.

32. The method of claim 1, wherein the pressure is a first pressure and the workpiece comprises a first layer of composite material and a second layer of composite material on the first layer, the method further comprising:
bonding the first layer to the second layer by applying the first pressure to the first portion, applying a second pressure to the second portion, irradiating the first portion, and irradiating the second portion;
placing a third layer of the composite material on the second layer;
irradiating, via the heating element, a third portion of the second layer and the third layer of the workpiece with the electromagnetic radiation, thereby heating the third portion of the workpiece;
applying a third pressure to the third portion via the actuator, thereby bonding the second layer to the third layer;
making a second determination that a second condition of the third portion or the actuator satisfies the one or more criteria; and
moving the workpiece and/or the actuator, in response to making the second determination, such that a fourth portion of the second layer and the third layer of the workpiece is aligned with the actuator.

33. (canceled)

34. A non-transitory computer readable medium storing instructions that, when executed by one or more processors of a bonding system, cause the bonding system to perform the method of claim 1.

35. A bonding system comprising:
one or more processors;
a heating element;
an actuator; and
a computer readable medium storing instructions that, when executed by the one or more processors, cause the bonding system to perform functions comprising:
irradiating, via the heating element, a first portion of a workpiece with electromagnetic radiation having an oscillation frequency within a range of 1 MHz to 300 MHz, thereby heating the first portion of the workpiece;
applying a pressure to the first portion of the workpiece via the actuator;
making a determination that a condition of the first portion or the actuator satisfies one or more criteria; and
moving the workpiece and/or the actuator, in response to making the determination, such that a second portion of the workpiece is aligned with the actuator.
